(19) United States
(12) Patent Application Publication
(10) Pub. No.: US 2012/0182473 A1
(43) Pub. Date: Jul. 19, 2012

(54) MECHANISM FOR CLOCK RECOVERY FOR STREAMING CONTENT BEING COMMUNICATED OVER A PACKETIZED COMMUNICATION NETWORK

(76) Inventors: Gyudong Kim, Sunnyvale, CA (US); Hoon Choi, Mountain View, CA (US); Richard J. Wilcox, Sagle, ID (US); Chandlee Harrell, Los Altos, CA (US)

(21) Appl. No.: 13/339,339

(22) Filed: Dec. 28, 2011

Related U.S. Application Data
(60) Provisional application No. 61/433,061, filed on Jan. 14, 2011.

(51) Int. Cl. H04N 5/06; H04L 7/00

(52) U.S. Cl. 348/521; 375/354; 348/E05.011

(57) ABSTRACT

A mechanism for facilitating clock recovery for streaming content over a packetized network is described. A method of embodiments includes receiving an estimated data stream at a first device. The estimated data stream may include estimated data format information relating to a data stream expected to be received at the first device. The method may further include performing, at the first device, clock regeneration of the estimated data stream based on the estimated data format information. The clock regeneration may include performing clock recovery of the estimated data stream.

### CLAIM OF PRIORITY

This application claims the benefit of U.S. Provisional Patent Application No. 61/433,061, entitled “MECHANISM FOR RECOVERING CLOCK FOR STREAMING CONTENT OVER A PACKETIZED NETWORK” by GYUDONG KIM, filed Jan. 14, 2011 (Attorney Docket No. 8029P104Z), the entire contents of which are incorporated herein by reference and priority is claimed thereof.

### TECHNICAL FIELD

Embodiments of the invention generally relate to the field of network communication and, more particularly, to a mechanism for facilitating clock recovery for streaming content being communicated over a packetized communication network.

### BACKGROUND

Clock recovery in streaming content has been extensively researched and refined. However, clock recovery in a packetized network environment poses a different set of unresolved problems relating to, for example, network-added jitters to the arrival of packets. For example, conventional techniques support only one fixed clock (e.g., 27 MHz), while video and audio clocks are recovered independently, and the buffer pointer control is not extensive. These jitters can be due to and of various forms, such as added jitters, dropped packets, received packets with invalid timing information, packets arriving out of order, or simple bit errors in time stamps that could be interpreted as added jitters.

### SUMMARY

A method of embodiments includes facilitating clock recovery for streaming content over a packetized network is described. A method of embodiments includes receiving an estimated data stream at a first device. The estimated data stream may include estimated data format information relating to a data stream expected to be received at the first device. The method may further include performing, at the first device, clock regeneration of the estimated data stream based on the estimated data format information. The clock regeneration may include performing clock recovery of the estimated data stream.

In one embodiment, the aforementioned clock regeneration may include performing clock recovery of the estimated data stream based on the data format information to facilitate seamless displaying of the clock regenerated data stream. The performing of clock recovery may include examining arrival time of time stamps inserted in the data stream by the source for adjustment of local frequency or examining over time the depth level in a received First-In-First-Out (FIFO) for adjustment of local frequency or a combination of the two. Further, enhancing the clock recovery may be performed by one or more of eliminating outliers, performing a narrow bandwidth clock recovery, and shifting phase noise outside an audible range. In one embodiment, content of the data stream may include at least one of High-Definition Multimedia Interface (HDMI)-based content, Digital Video Interface (DVI)-based content, or Mobile High-Definition Link (MHL)-based content, and wherein the content includes at least one of video content or audio content.

In some aspects of the invention, apparatus and system of the embodiments perform the aforementioned method.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1A illustrates a source device having a data format estimation module according to one embodiment of the invention;

FIGS. 1B illustrates a sink device having a clock regeneration module according to one embodiment of the invention;

FIGS. 2 illustrates a clock recovery mechanism for clock recovery for streaming data content over a packetized network according to one embodiment of the invention;

FIG. 3 illustrates a sequence for facilitating clock recovery of packetized streaming content according to one embodiment of the invention; and

FIG. 4 illustrates a computer system according to one embodiment of the invention.

### DETAILED DESCRIPTION

Embodiments of the invention are generally directed to facilitating clock recovery for streaming content being communicated over a packetized communication network.

Embodiments of the invention provide for a mechanism for clock recovery for streaming content over a packetized network, such as Ethernet. In one embodiment, certain tasks (e.g., video format estimation) are performed at a source (e.g., a transmitter of the content stream), while certain other tasks (e.g., clock regeneration) are performed at a sink (e.g., a receiver of the content stream). For example, embodiments of the invention further provide estimating video clock frequency at the source side from the video format estimated by counting clocks with respect to horizontal synchronization (HSYNC) and vertical synchronization (VSYNC) pulses and audio spectrum aware clock recovery to minimize audible noise due to the clock recovery process. Embodiments of the invention provide for enhancing the user experience of receiving uncompressed and/or compressed streaming media being communicated over one or more packetized networks. It is to be noted that throughout the document, “source” is further referred to as “source device”, “transmitter”, “transmitting device”, or simply “Tx”. Similarly, “sink” is further referred to as “sink device”, “receiver”, “receiving device”, or simply “Rx”.

Video clock in displays, such as modern digital Liquid Crystal Display (LCD)/Plasma displays, plays a role in driving the display electronics from video processors, timing controllers, data/gate drivers, etc. The frequency accuracy is often specified in the related specifications, such as the High-Definition Multimedia Interface (HDMI) Specification 1.4a. The jitter requirements are mainly related to timing margins in the driven display electronics. If the recovered video clock has a frequency offset from the source clock, eventually there may be pixel drop/gain that may not be resolved easily since video display timing may not allow an irregular number of clocks per given period. Audio clock, however, may have different requirements. Although there may be no outstanding frequency/jitter requirements in the related specifications, if the phase noise is within the audible frequency range (usually assumed to be within 20 Hz to 20 kHz), the change of a tone could be audible, which could impact user experience.

Some streaming media standards, such as HDMI and Digital Visual Interface (DVI), send clock and data at the same time. This way, any frequency within a certain range can be supported through the specification and specification-compliant devices without the complication of clock recovery. Another streaming media standard, such as a display port, supports a handful of pre-selected discrete frequencies to ease the clock recovery for video electronics. Regardless of whether a source media standard supports a continuous range of clock frequencies or a handful of pre-selected discrete frequencies, once the media data (such as video, audio, control, etc.) are packetized and transferred over a network, recovering the source clocks for the audio and video contents may not be trivial.

For example, a data link is assumed. Information regarding the incoming video mode, such as video format and pixel clock rate, is obtained. A nominal clock frequency identified from the video mode information is generated and the process waits until the First-In-First-Out (FIFO) memory is filled to the desired position that is able to support bounded network jitter, such as out of order arrival, packet drop, packet error, etc. Then, a video stream with the nominal clock is regenerated. If the local clock lags the incoming time stamp, the local clock phase is advanced. If the local clock leads the incoming time stamp, the local clock phase is delayed. The control of the local clock phase is dictated by the control loop bandwidth to be below or above the audible frequency range and the absolute frequency tolerance imposed by the regenerating video standard (0.5% in HDMI, for example).

By starting at the nominal frequency provided by the video mode, arbitrary video clock can be supported. By observing buffer depth and/or time stamp, local clock can track the remote clock while coping with the network jitter. In one embodiment, the control loop recovers the local clock in a way that the frequency change for tracking is not discernible to human ears.

The recovered video clock may need to satisfy, for example per given video mode, compliance testing with respect to the related specifications, such as the Compliance Test Specification (CTS) of HDMI. The variation of the video clock could be perceived as the variation of the audio clock which could be a lot more obvious from the tone changes than the video clock where lip-sync could be important to some extent. Limiting the bandwidth of the control loop below a certain frequency range (e.g., 20 Hz or beyond 20 kHz) (out of audible frequency range) may help the process. Due to causality of a signal, most of the jitter through the network delays the video. Therefore, simply maintaining the buffer pointer at the center of the stream buffer may not be sufficient.

Embodiments provide for recovering media clock, such as video clock or audio clock, when a streaming media data is transferred through a fixed or selectable discrete data bandwidth network and is reconstructed on the other side as the original streaming media data. More particularly, embodiments provide for when the length of a media data packet is fixed or predictable, such as uncompressed base band video or flow-controlled compressed video, where the predictability of the packet length can be exploited for clock recovery. The nature of a serial link could cause the packet length varying due to unavoidable bit errors.

As used herein, “network” or “communication network” mean an interconnection network to deliver digital media content (including music, audio/video, gaming, photos, and others) between devices. A network may include a personal entertainment network, such as a network in a household, a network in a business setting, or any other network of devices and/or components. In a network, certain network devices may be a source of media content, such as a digital television tuner, cable set-top box, video storage server, and other source device. Other devices may display or use media content, such as a digital television, home theater system, audio system, gaming system, or presented over the Internet in a browser, and other devices. Further, certain devices may be intended to store or transfer media content, such as video and audio storage servers. Certain devices may perform multiple media functions. In some embodiments, the network devices may be co-located in a single local area network. In other embodiments, the network devices may span multiple network segments, such as through tunneling between local area networks. The network may include multiple data encoding and encryption processes.

It is contemplated that a number of logic/circuits may be employed at receiver and transmitter chips, such as a locking circuit, Phase Locked Loop (PLL), Delay Locked Loop (DLL), encryption logic, decryption logic, authentication engine, one or more (background/foreground) processing engines, or the like. As will be described throughout this document, that a data stream (e.g., video and/or audio data stream) may include HDMI-based content, Digital Visual Interface (DVI)-based content, or Mobile High-Definition Link (MHL)-based content; however, embodiments of the invention are not limited to HDMI, DVI, and MHL and may be used for any other type of data streams. Similarly, embodiments of the invention are not limited to HDCP and can be applied to and used with other encryption protocols or mechanisms. However, HDMI, DVI, and MHL or the like are used here for brevity, clarity, and ease of explanation.

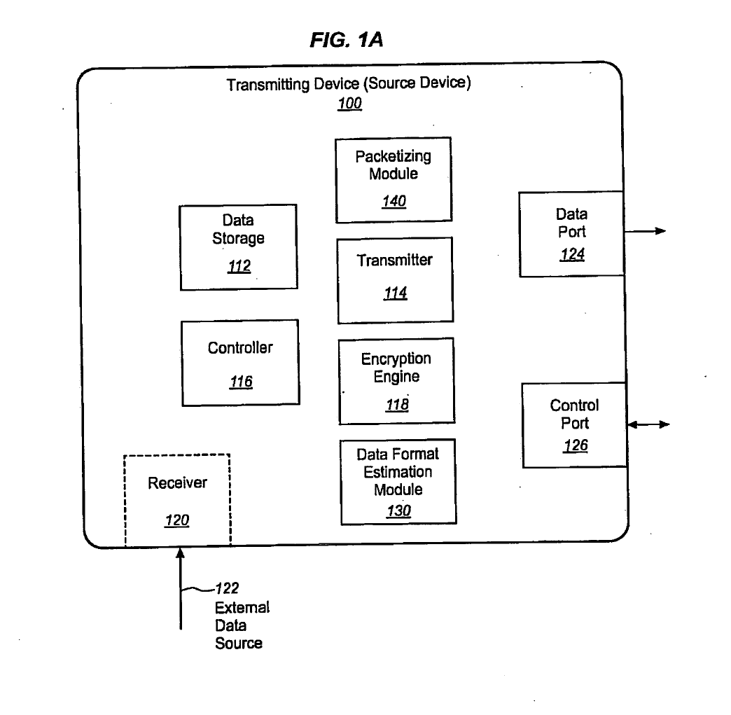

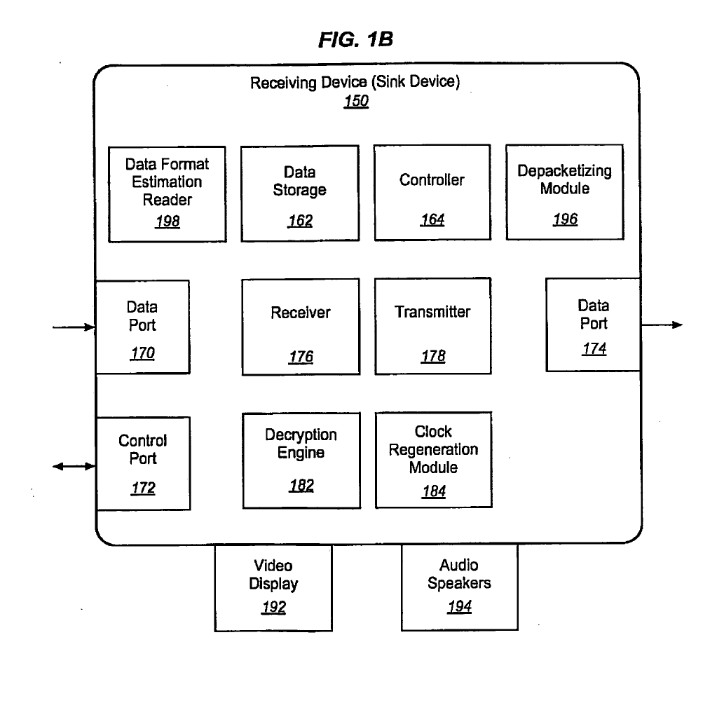

FIG. 1A illustrates a source device having a data format estimation module according to one embodiment of the invention. In some embodiments, a source device 100 includes a transmitter 114 for the transmission of data streams, a controller 116 to control data transmission, and an encryption engine 118 to encrypt content of a data stream prior to transmission to another device (e.g., a receiving device, such as a sink device or an intermediary bridge device). The source device 100 may further include data storage 112 for storage of data prior to transmission, and a receiver 120 to receive certain data from an external data source 122 prior to transmission.

The source device 100 may further include a data port 124 and a control port 126. In one embodiment the data and control ports 124, 126 may be logically separated and, in another embodiment, data and control ports 124, 126 may be physically separated or have a single physical port that has multiple logical ports. In yet another alternative, more than one physical port may be employed per each logical port of data and control ports 124, 126 and that some of the “format” information may be sent over the data port 124 as opposed to the control port 126. The source device 100 may change the transmission of data stream during operation, such as while transmitting the data stream in multiple different modes over the data port 124 may, for example, transition from a first mode to a second mode. The source device 100 transmits a message via the control port 126 to inform (or warn) a receiving device of certain situations, such as letting the sink device know that the source device 100 is sending a data stream, such as an encrypted (packetized) data stream. The source device 100 then may wait until an acknowledgement (ACK) is received at the control port 126 before transmitting another data stream or may continue transmitting without having received the acknowledgement.

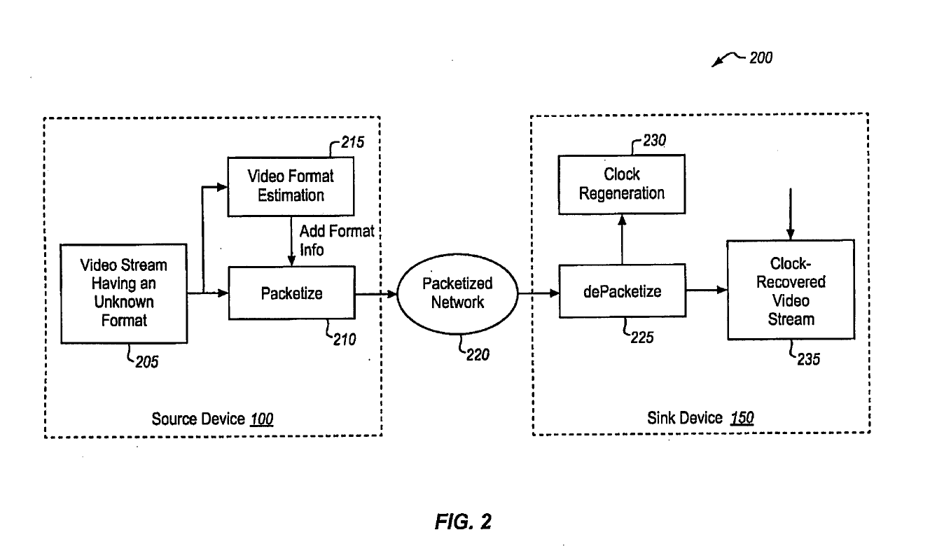

The source device 100 includes a packetizing module 140 to packetize the data stream to be transmitted to a sink device over a packetized network (e.g., Ethernet). The packetizing module 140 is used to packetize the data stream which may then be multiplexed and encrypted by the encryption engine 118 to be transmitted to a sink device. In one embodiment, the source device 100 further employs a data format estimation (DFE) module 130 (e.g., video format estimation) to put the data stream (e.g., video stream) in the estimated data format (e.g., video format) or mode to be sent to the sink device so that any information provided by the data format estimation may be tagged to the data stream and used to estimate, for example, the target recovered pixel clock frequency. This will be further discussed with reference to FIG. 2. It is contemplated that any number of components of the source device 100 may include software, hardware, or any combination thereof, such as firmware.

FIG. 1B illustrates a sink device having a clock regeneration module according to one embodiment of the invention. In some embodiments, a sink device 150 may serve as a downstream receiving device to receive packetized data streams having data format estimation and provide or render the data stream through a video display 192 and audio speakers 194. In one embodiment, the bridge device 120 includes a data format estimation reader 198 that may include a number of components and modules to facilitate the sink device 150 to identify the data format assigned to the data stream at the source device, and to identify, access, read, comprehend and even modify the data stream being received from a source device. The sink device 150 further includes a depacketizing module 196 to recover the data stream packetized at the source device. The sink device 150 further includes a clock regeneration module 184 to regenerate the clock by controlling the frequency of the recovered clock based on received time stamps and/or on a First-In-First-Out (FIFO) pointer. This will be further described with reference to FIG. 2. As with the source device of FIG. 1A, various components of the sink device 150 include software, hardware, or a combination thereof, such as firmware.

The sink device 150 may include a controller 164 to control data operation, a receiver 176 to receive a data stream, a transmitter 178 to transmit a data stream, together with data ports 170 and 174 for reception and transmission, respectively, of a data stream, and a control port 172 for exchange of commands with the transmitting device. The sink device 150 may be coupled with one or more devices, such as a video display 192, audio speakers 194, a data storage device 162 for storage of received content of the data stream, or the like. In one embodiment, the sink device 150 is capable of receiving a partially-encrypted data stream and is further capable of examining and even modifying the unencrypted content (e.g., control content) of the data stream without decrypting or re-encrypting the unencrypted content or even participating in the authentication process of the unencrypted content.

In one embodiment, the sink device 150 includes a decryption engine 182 that includes a number of entities to facilitate the sink device 150 to identify and decrypt the encrypted content of the data stream as well as to identify, access, read, and comprehend the unencrypted content of the data stream being received from a source device. The sink device 150 may provide any of the content of the data stream through the video display device 192 and/or the audio speakers 194.

FIG. 2 illustrates a clock recovery mechanism for clock recovery for streaming data content over a packetized network according to one embodiment of the invention. In one embodiment, a mechanism for clock recovery (“mechanism for clock recovery”) 200 for streaming data content over a packetized network (e.g., Ethernet) is illustrated as being applied to a data stream (e.g., video stream) being communicated between a source device 100, and a sink device 150. It is contemplated that the video stream can assume that the content transfer of the video stream (and thus its contents) is reliable in the sense that the transfer is cycle-accurate and the data stream content is to be transferred in its entirely (or as, for example, requested by the sink device) and in a particular predetermined order. For example, the HDMI Specification may mandate that the video clock relating to the video stream needs to be within 0.5% of tolerance from each defined video clock frequency. Since a video stream transfer is assumed to be transparent, it contains no information regarding the characteristics of the video included in the video stream. This is typically the case with DVI. With regard to HDMI, a video information frame may be added to the video stream to provide information about the video stream's video mode. However, the information could be wrong and unless it is properly worked around, a single error in the video information frame could significantly impact a user's video watching experience. Consequently, knowing video timing format and clock frequency and/or committing clock recovery become important.

In the illustrated embodiment, a video stream of an unknown format (“unknown format video stream”) 205 is initiated at the source device 100. The unknown format video stream 205 is then packetized (e.g., sent as series of packets over a packetized network 220 to the sink device 150. In one embodiment, a novel technique of video format estimation 215 is applied to unknown format video stream 205 at the source device 100 to promote the unknown format video stream 205 into a video stream that has format information added to it. This video format information is then sent to the sink device 150 so that the format information can be used to estimate target recovered clock frequency. Even with the accurate target clock frequency known, clock recovery is used because no two reference clock frequencies are the same. For example, this is could be because base crystal oscillators' frequencies are different or this could be from any jitter in the source-based video stream.

In one embodiment., the video format estimation 215 is assigned to or associated with the unknown format data stream 205 at the source device 100 because the source device 100 is in a better position than a sink device 150 to estimate the ideal video clock frequency. Further, the source device 100 is better positioned to guess what the ideal video clock frequency ought to be acceptable. In one embodiment, at the source device 100, the media clock frequency is estimated by counting HSYNC, VSYNC, and DE ratio and the relationships between events in these signals. Using this technique, there may not remain a need to estimate the format of the input video by counting the ratio between HSYNC and VSYNC on the sink device 150.

In one embodiment, at the sink device 150, clock regeneration 230 is performed on the data stream to control the regenerated clock frequency based, for example, on the FIFO pointer location. However, as aforementioned, the known target frequency and the known frequency tolerance, the cycle-to-cycle jitter that affects timing in the logic, and the frequency wander that could trigger a protection mechanism in the sink device 150 may be controlled within a tolerable range. Clock Regeneration 230, in one embodiment, uses the video format estimation 215 for clock recovery. For example, the video stream received through the packetized network 220 is received as series of packets and it is contemplated that there remains a chance that some of the sent packets may end up not arriving at the sink device 150 and/or some of the packets may arrive out-of-order. Since these missing or out-of-order packets can make the data fluctuate in the FIFO, controlling the frequency of the recovered clock based on the FIFO pointer is regarded as regenerating the clock. When the FIFO has more than half the data of the video stream, the clock frequency may be gradually increased; in contrast, when the FIFO has less than half the data, the clock frequency is gradually decreased. In this way, any under-run or over-run of the data can be prevented.

Any potential fluctuation of data in the FIFO is prevented by knowing the video format estimation that provides information relating to what happened to each data packet of the data stream being received at the sink device 150. In other words, in one embodiment, using the video format estimation 215, any missing or out-of-order packets of the video stream are determined and identified and, accordingly, the FIFO pointer is then adjusted.

Furthermore, in some audio/video (AJV) interfaces, such as an HDMI or a DisplayPort, the audio can be simultaneously transferred with the. video as part of a data stream. For example, an audio clock can be recovered with respect to a video clock or some very high-end audio D/A converters can be used to remove most of the incoming clock jitter. This is due to the high cost of loop filter (either on-board analog components or on-chip analog or digital loop components/circuitry) and the data FIFO that is used to avoid data loss. To avoid the cost, clock regeneration 230 is used such that a regenerated audio clock can be cleaned and a clean audio clock can be obtained, which the recovered video clock need not change its phase or its frequency often so that any the jitter in the audio clock can be prevented. However, so long as the added jitter frequency is not within the audible range, the jitter does not affect the perceived audio quality of the data stream. In one embodiment, the controlling of the jitter in a band-reject filter can be achieved with, for example, Fractional-N synthesis.

In the illustrated embodiment, an unknown format data stream 205 (e.g., video stream) is initiated at the source device 100. The data stream 205 is then packetized 210, and video format estimation 215 is added to the data stream 205 by associating relevant format information to the data stream 205. In one embodiment, format information includes, at the source device 100, the media clock frequency being estimated by counting HSYNC, VSYNC, and DE ratio and the relationships between events in these signals. Using this technique, there may not remain a need to estimate the format of the input video by counting the ratio between HSYNC and VSYNC on the sink device 150. A transformed data stream 235, having the format information, is packetized and sent over the packetized network 200. The transformed data stream 235 is received at sink device 150 where it is depacketized 225 and probed for clock regeneration 230. Using the video format estimation 215 providing the relevant format information, the clock regeneration module at the sink device 150 regenerates the clock associated with the data stream 235. Using clock regeneration 230, clock recovery is performed by recovering the media clock relating to the data stream 235 to reduce any potential jitters, such as video shift or audible phase noise.

In one embodiment, various ways to perform clock regeneration 230 for clock recovery include eliminating outliers (e.g., judge outliers relatively easily if, for example, time stamping is performed at a fixed rate), performing a narrow bandwidth clock recovery if the target frequency is known beforehand, such as from the video format estimation 215, and shifting of phase noise outside the audible range. Further, clock regeneration 230 may be performed using a variable clock frequency input to find or recover clock in order to generate clock time stamp by finding HSYNC and VSYNC and looking at HDMI AVI information frame provided as the format information added to the data stream as part of the process of video format estimation 215.

In one embodiment, employing the process of clock regeneration 230 that includes estimating clock frequency (to recover clock) being performed at the sink device 150 over the packetized network 220 to provide an accurate clock recovery and frequency estimate, is used in addition to the AVI info frame in HDMI. Further, with a common clock (or a clock with known nominal frequency at both source and sink devices 100, 150), a time stamp can be generated repeatedly to provide information for frequency adjustments at the sink device 150. If a clock is not available or guaranteed, the count of clock periods between each media packet of the data stream can be regarded as sufficient information for clock recovery, if this is combined with the frequency estimation provided by the format estimation 215 performed at the source device 100.

In recovering the clock for the data stream 235, avoiding the audible tones improves the user experiences. In one embodiment a method to avoid the audible tones is to shape the noise in a frequency band higher than the audible frequency range, such as higher than 20 kHz, because once the noise is shaped to a higher frequency band, the noise becomes relatively easy to filter out and in some cases, there may not remain any need to filter out the noise as the noise may not be audible.

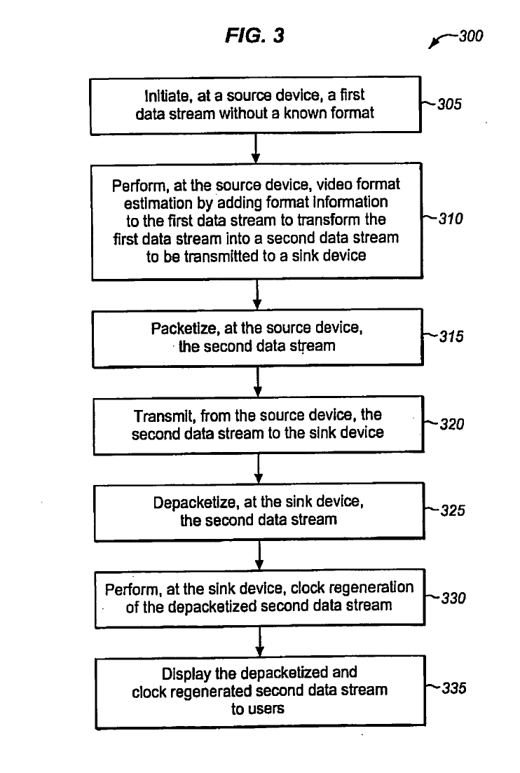

FIG. 3 illustrates a sequence for facilitating clock recovery of a packetized stream according to one embodiment of the invention. Method 300 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 300 is performed by the mechanism for clock recovery 200 of FIG. 2 employed by the source and sink devices 100, 150 of FIGS. 1A and 2B.

At block 305, a first data stream (e.g., video and/or audio stream) that lacks format or whose format is not known (e.g., unknown format data stream 205 of FIG. 2) is initiated at a source device. It is contemplated that the first data stream may have been received from another device or location (e.g., a cable broadcaster) or generated at the source device which serves as a transmitter of data streams. At block 310, a data format estimation process is performed for the first data stream at the source device and appropriate format estimation is determined for and assigned to the first data stream. Assigning the appropriate format estimation includes associating format information to the first data stream which transforms the first data stream into a second data stream that is to be transmitted to a sink device. At block 315, the second data stream is then packetized into smaller packets to be transmitted to the sink device over a packetized network (e.g., Ethernet) at block 320.

At block 325, the second data stream is then received and depacketized at the sink device. At block 330, a clock regeneration process of the second data stream is performed at the sink device. The clock regeneration process includes performing clock recovery of the second data stream at the sink device to adjust the second data stream so that the second data stream can be seamlessly provided to users without any jitters for maximum enjoyment. At block 335, the depacketized and clock regenerated second data stream is displayed to the user via a display device in communication with the sink device which serves as the receiver of the second data stream.

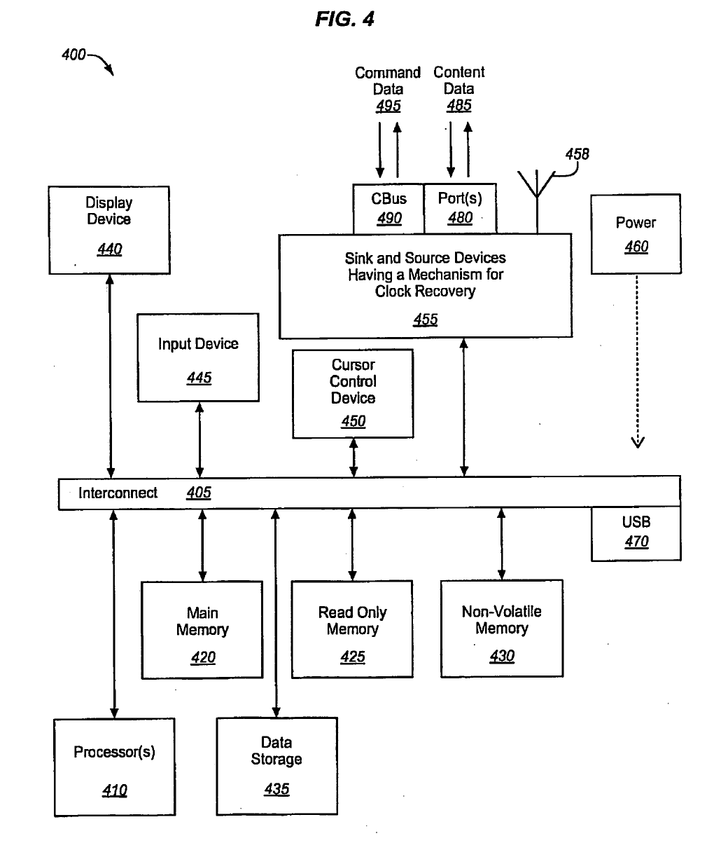

FIG. 4 illustrates a computing system for employing a mechanism for clock recovery 200 of FIG. 2 performed the source and sink devices 100, 150 of FIGS. 1A and 2B according to one embodiment of the invention. In this illustration, certain standard and well known components that are not germane to the present description are not shown. Under some embodiments, the computing system or device 400 may fully or partially employ or be part of a source device, a sink device, or both 455.

Under some embodiments, the device 400 comprises an interconnect or crossbar 405 or other communication means for transmission of data. The data may include audio-visual data and related control data. The device 400 may include a processing means such as one or more processors 410 coupled with the interconnect 405 for processing information. The processors 410 may comprise One or more physical processors and one or more logical processors. Further, each of the processors 410 may include multiple processor cores. The interconnect 405 is illustrated as a single interconnect for simplicity, but may represent multiple different interconnects or buses and the component connections to such interconnects may vary. The interconnect 405 shown here is an abstraction that represents any one or more separate physical buses, point-to-point connections, or both connected by appropriate bridges, adapters, or controllers. The interconnect 405 may include, for example, a system bus, a PCI or PCIe bus, a HyperTransport or industry standard architecture (ISA) bus, a small computer system interface (SCSI) bus, a RC (I2C) bus, or an Institute of Electrical and Electronics Engineers (IEEE) standard 1394 bus, sometimes referred to as “Firewire”, or also may be a network such as Ethernet. (“Standard for a High Performance Serial Bus”0 1394-1995, MEE, published Aug. 30, 1996, and supplements) The device 400 further may include a serial bus, such as USB bus 470, to which may be attached one or more USB compatible connections.

In some embodiments, the device 400 further comprises a random access memory (RAM) or other dynamic storage device as a main memory 420 for storing information and instructions to be executed by the processors 410. Main memory 420 also may be used for storing temporary variables or other intermediate information during execution of instructions by the processors 410. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may certain registers or other special purpose memory. The device 400 also may comprise a read only memory (ROM) 425 or other static storage device for storing static information and instructions for the processors 410. The device 400 may include one or more non-volatile memory elements 430 for the storage of certain elements.

Data storage 435 may also be coupled to the interconnect 405 of the device 400 for storing information and instructions. The data storage 435 may include a magnetic disk, an optical disc and its corresponding drive, or other memory device. Such elements may be combined together or may be separate components, and utilize parts of other elements of the device 400.

The device 400 may also be coupled via the interconnect 405 to a display or presentation device 440. In some embodiments, the display may include a liquid crystal display (LCD), a plasma display, a cathode ray tube (CRT) display, or any other display technology, for displaying information or content to an end user. In some embodiments, the display 440 may be utilized to display television programming. In some environments, the display 440 may include a touch-screen that is also utilized as at least a part of an input device. In some environments, the display 440 may be or may include an audio device, such as a speaker for providing audio information, including the audio portion of a television program. An input device 445 may be coupled to the interconnect 405 for communicating information and/or command selections to the processors 410. In various implementations, the input device 445 may be a keyboard, a keypad, a touch screen and stylus, a voice activated system, or other input device, or combinations of such devices. Another type of user input device that may be included is a cursor control device 450, such as a mouse, a trackball, or cursor direction keys for communicating direction information and command selections to the one or more processors 410 and for controlling cursor movement on the display 440.

One or more source and sink devices 455 may also be coupled to the interconnect 405. In one embodiment, the source and sink devices 455 may include some or all of the mechanism for clock recovery as described with reference to FIG. 3. In some embodiments the device 400 may include one or more ports 480 for the reception or transmission of data. Data that may be received or transmitted may include video data or audio-video data, such as HDMI data, and may be encrypted, such as HDCP encrypted data. In some embodiments, the device 400 is a receiving or sink device, and operates to select a port for the reception of data, while sampling data from one or more other ports to determine whether the data received at the ports that have not been selected for foreground processing is encrypted. The device 400 may further include one or more antennas 458 for the reception of data via radio signals. The device 400 may also comprise a power device or system 460, which may comprise a power supply, a battery, a solar cell, a fuel cell, or other system or device for providing or generating power. The power provided by the power device or system 460 may be distributed as required to elements of the device 400.

In the description above, for the purposes of explanation, numerous specific details are set forth in order to provide a thorough understanding of the present invention. It will be apparent, however, to one skilled in the art that the present invention may be practiced without some of these specific details. In other instances, well known structures and devices are shown in block diagram form. There may be intermediate structure between illustrated components. The components described or illustrated herein may have additional inputs or outputs which are not illustrated or described. The illustrated elements or components may also be arranged in different arrangements or orders, including the reordering of any fields or the modification of field sizes.

The present invention may include various processes. The processes of the present invention may be performed by hardware components or may be embodied in machine-readable instructions (e.g., computer-readable instructions), which may be used to cause a general purpose or special purpose processor or logic circuits programmed with the instructions to perform the processes. Alternatively, the processes may be performed by a combination of hardware and software.

Portions of the present invention may be provided as a computer program product, which may include a non-transitory machine-readable medium (e.g., non-transitory computer-readable medium) having stored thereon computer program instructions, which may be used to program a computer (or other electronic devices) to perform a process according to the present invention. The computer-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/computer-readable medium suitable for storing electronic instructions. Moreover, the present invention may also be downloaded as a computer program product, wherein the program may be transferred from a remote computer to a requesting computer.

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

What is claimed is:

1. A method comprising:
receiving an estimated data stream at a first device, wherein the estimated data stream includes estimated data format information relating to a data stream expected to be received at the first device; and
performing, at the first device, clock regeneration of the estimated data stream based on the estimated data format information, wherein clock regeneration includes performing clock recovery of the estimated data stream.

2. The method of claim 1, wherein estimation of the data stream is performed at a second device and transmitted to the first device, wherein the first device includes a sink device, and wherein the second device includes a source device.

3. The method of claim 1, further comprising packetizing, at the second device, the estimated data stream, and wherein depacketizing, at the first device, the estimated data stream prior to performing clock regeneration.

4. The method of claim 1, wherein clock regeneration comprises performing clock recovery of the estimated data stream based on the data format information to facilitate seamless displaying of the clock regenerated data stream at a display device coupled to the first device.

5. The method of claim 1, wherein performing clock regeneration comprises examining arrival time of time stamps inserted in the data stream by the source for adjustment of local frequency or examining over time the depth level in a received First-In-First-Out (FIFO) for adjustment of local frequency.

6. The method of claim 5, further comprising enhancing the clock recovery by one or more of eliminating outliers, performing a narrow bandwidth clock recovery, and shifting phase noise outside an audible range.

7. The method of claim 1, wherein content of the data stream comprises at least one of High-Definition Multimedia Interface (HDMI)-based content, Digital Video Interface (DVI)-based content, or Mobile High-Definition Link (MHL)-based content, and wherein the content includes at least one of video content or audio content.

8. A system comprising:
a first device having data processing capabilities, the first device to:
receive an estimated data stream, wherein the estimated data stream includes estimated data format information relating to a data stream expected to be received at the first device; and
perform clock regeneration of the estimated data stream based on the estimated data format information, wherein clock regeneration includes performing clock recovery of the estimated data stream.

9. The system of claim 8, wherein estimation of the data stream is performed at a second device and transmitted to the first device, wherein the first device includes a sink device, and wherein the second device includes a source device.

10. The system of claim 8, wherein the second device is further to packetize the estimated data stream, and wherein the first device is further to depacketize the estimated data stream prior to performing clock regeneration.

11. The system of claim 8, wherein clock regeneration comprises performing clock recovery of the estimated data stream based on the data format information to facilitate seamless displaying of the clock regenerated data stream at a display device coupled to the first device.

12. The system of claim 8, wherein performing clock regeneration comprises examining arrival time of time stamps inserted in the data stream by the source for adjustment of local frequency or examining over time the depth level in a received First-In-First-Out (FIFO) for adjustment of local frequency.

13. The system of claim 12, wherein the clock recovery is enhanced by one or more of eliminating outliers, performing a narrow bandwidth clock recovery, and shifting phase noise outside an audible range.

14. The system of claim 8, wherein content of the data stream comprises at least one of High-Definition Multimedia Interface (HDMI)-based content, Digital Video Interface (DVI)-based content, or Mobile High-Definition Link (MHL)-based content, wherein the content includes at least one of video content or audio content.

15. A machine-readable medium including instructions which, when executed by machine, cause the machine to:
receiving an estimated data stream at a first device, wherein the estimated data stream includes estimated data format information relating to a data stream expected to be received at the first device; and
performing, at the first device, clock regeneration of the estimated data stream based on the estimated data format information, wherein clock regeneration includes performing clock recovery of the estimated data stream.

16. The machine-readable medium of claim 15, wherein estimation of the data stream is performed at a second device and transmitted to the first device, wherein the first device includes a sink device, and wherein the second device includes a source device.

17. The machine-readable medium of claim 15, wherein the machine is further to packetize, at the second device, the estimated data stream, and depacketize, at the first device, the estimated data stream prior to performing clock regeneration.

18. The machine-readable medium of claim 15, wherein clock regeneration comprises performing clock recovery of the estimated data stream based on the data format information to facilitate seamless displaying of the clock regenerated data stream at a display device coupled to the first device.

19. The machine-readable medium of claim 15, wherein performing clock regeneration comprises examining arrival time of time stamps inserted in the data stream by the source for adjustment of local frequency or examining over time the depth level in a received First-In-First-Out (FIFO) for adjustment of local frequency.

20. The machine-readable medium of claim 19, wherein the processing device is further to enhance the clock recovery by one or more of eliminating outliers, performing a narrow bandwidth clock recovery, and shifting phase noise outside an audible range.

21. The machine-readable medium of claim 15, wherein content of the data stream comprises at least one of High-Definition Multimedia Interface (HDMI)-based content, Digital Video Interface (DVI)-based content, or Mobile High-Definition Link (MHL)-based content, wherein the content includes at least one of video content or audio content.
